(19) United States
(12) Patent Application Publication
(10) Pub. No.: US 2014/0155097 A1
(43) Pub. Date: Jun. 5, 2014

(54) Location Based Reminders

(71) Applicant: Matthew Sean Tucker, Fort Lauderdale, FL (US)

(72) Inventor: Matthew Sean Tucker, Fort Lauderdale, FL (US)

(21) Appl. No.: 13/924,555

(22) Filed: Jun. 22, 2013

Related U.S. Application Data
(60) Provisional application No. 61/663,532, filed on Jun. 23, 2012.

(51) Int. Cl. H04W 4/02

(52) U.S. Cl. CPC H04W 4/02
USPC 455/456.3

(57) ABSTRACT

A system and method of monitoring triggers that alert a user of a location based reminder. At least one trigger may be at least one class having a plurality of members. The triggers are stored. The device monitors the location of the device in relation to the at least one trigger. An alert is executed when the device is within a threshold of the trigger. The device will continue to monitor outstanding triggers.

### CROSS-REFERENCE TO RELATED APPLICATION

This application claims the benefit of U.S. Patent Application No. 61/663,532 entitled Location Based Reminders that was filed on Jun. 23, 2012 with attorney docket No. 1281.001 and is hereby incorporated by reference in its entirety.

### FIELD OF THE INVENTION

The present invention relates to reminders, and in particular to a device, system and method for reminders based upon wireless device location.

### BACKGROUND OF THE INVENTION

Prior mobile computing device provide location based reminders based on one specific location set by a user. More specifically, a user can set various reminders that alert when the mobile computing device moves within a threshold of a specific location whereby the specific location is set by the user. For example, the user could set a reminder on the mobile device so that arriving at work alerts the user to go to a meeting whereby work is a specific location or address. Alternatively, the user could set a reminder on the mobile device so that leaving a specific location or address alerts the user. For example, the user could set a reminder on the mobile device so that when the user leaves the specified location or address, an alert is generated to remind the user to pickup dry cleaning. The prior art reminders do not take advantage of advanced mapping and additional resource potential provided by the mobile computing device. Specifically, the prior location based reminders are limited because the user is required to specify the specific location or address as a trigger.

The instant invention addresses these and other short comings by providing user set classes that alert when the user nears a member of that class.

### SUMMARY OF THE INVENTION

The present invention advantageously provides a device, system and method for monitoring a location for a triggering event, the triggering event based on at least one class. Alerting once determined that the device is within a threshold range of at least one determined member of the class.

The present invention further provides a device, system and method for determining members of at least one class, at least one class formed of a plurality of members. An alert is executed when a device is within a threshold range of at least one determined member of the class.

The present invention further provides a device, system and method for an alert associated with a class of common characteristics. The alert is executed when a mobile device is within a threshold range of at least one member the class.

The present invention further provides a device, system and method for monitoring for a trigger, the trigger based on a plurality of class members. Alerting that a device is within a threshold range of at least one determined member of the class.

The present invention further provides a device, system and method for a location based reminder application to set a target class for a reminder item, the reminder application generating an alert when the mobile computing device is within a threshold range of at least one member of the class.

According to an embodiment of the present invention is provided a mobile computing device that includes a location based reminder application to set a target class for a reminder item. The reminder application generates an alert when the mobile computing device is within a threshold range of at least one member of the class.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a location based reminder system constructed in accordance with the principles of the present invention;

FIG. 2 is a flow chart of an exemplary process for trigger based monitoring of a class in accordance with the principles of the present embodiment;

FIG. 3 is a flow chart of an exemplary process for trigger based monitoring of class in relation to at least one highway exit in accordance with the principles of the present embodiment;

FIG. 4 is a block diagram of a location based reminder system that shares triggers between two or more devices constructed in accordance with the principles of the present embodiment;

FIG. 5 is a flow chart of an exemplary process of trigger based monitoring of a class in accordance with the principles of the present embodiment;

FIG. 6 is a flow chart of an exemplary process for trigger based monitoring of a class on a first device and alerting a second device in accordance with the principles of the present embodiment;

FIG. 7 is a block diagram of a system constructed in accordance with the principles of the present embodiment;

FIG. 8 illustrates an exemplary class populated by a plurality of members in relation to a device in accordance with the principles of the present embodiment;

FIG. 9 illustrates an exemplary class populated by a plurality of members in relation to a device in accordance with the principles of the present embodiment;

FIG. 10 illustrates an exemplary class populated by a plurality of members in relation to a device in accordance with the principles of the present embodiment; and

FIG. 11 illustrates an exemplary class populated by a plurality of members in relation to a device in accordance with the principles of the present embodiment.

### DETAILED DESCRIPTION OF THE INVENTION

The present invention advantageously provides a system and method for trigger based monitoring of a class and alerting of a member of the class.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

Before describing in detail exemplary embodiments that are in accordance with the present invention, it is noted that the embodiments reside primarily in combinations of apparatus components and processing steps related to monitoring for a triggering event, the triggering event based on a class, the class having a plurality of members. Alerting once determined that at least one monitored device is within a threshold of at least one determined member of the class, where the class includes a plurality of members.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

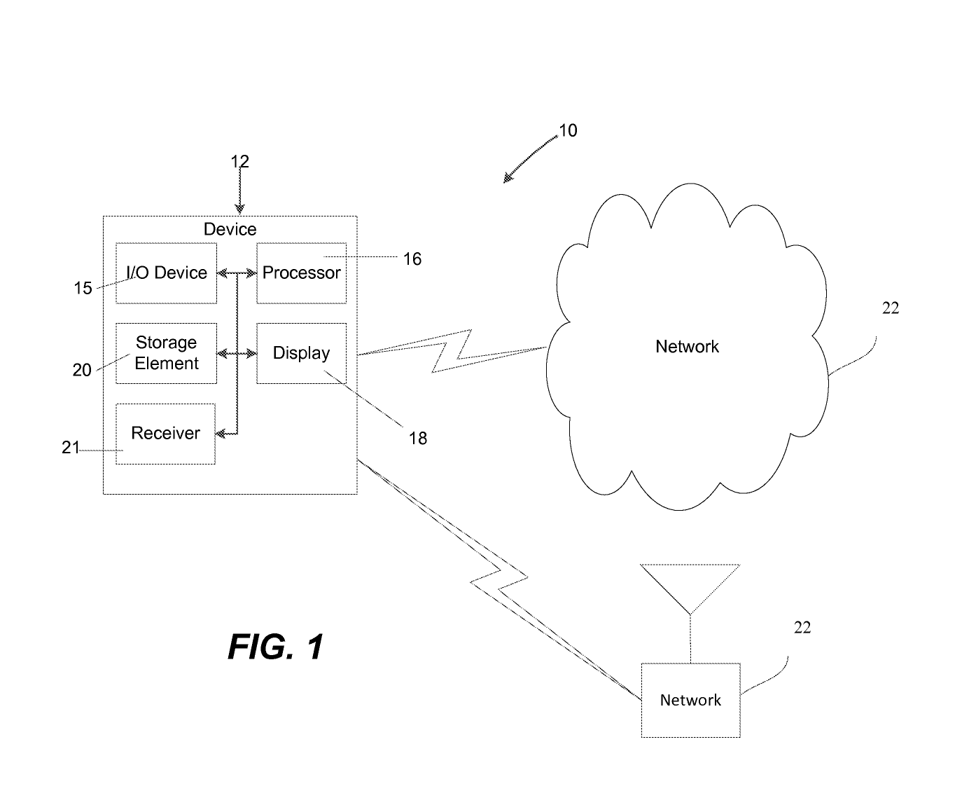

Referring now to the drawings figures in which like reference designators refer to like elements there is shown in FIG. 1 an exemplary embodiment constructed in accordance with the principles of the present invention and designated generally as “10.” As shown in FIG. 1, a device 12 may be connected to a network 22. Examples of a network include a cellular communication network and the Public Switched Telephone Network (PSTN), or other wide area network (WAN), such as the Internet, as well as local area networks (LANS), such as an Ethernet LAN. Network 22 may additionally be a wireless network, such as satellite, Wi-Fi, infrared, Near Field Communications, Bluetooth, or other communication networks. Furthermore, the network 22 may include GSM with General Packet Radio Service (GPRS) systems (GSM/GPRS), High Speed Downlink Packet Access (HSDPA) systems, Enhanced Data Rates for Global Evolution (Edge) systems, Evolution Data Only or Evolution Data Optimized (EV-DO), CDMA/1xRTT systems, Evolution for Data and Voice (EV-DV) systems, and so forth. The satellite may include any satellite. For example, the satellite may be a satellite navigation system. The network 22 may additionally include any type of network that is capable of providing a location of the device 12. For example, the network 22 may provide information to, inter alia, triangulate the location of the device 12.

A sample location may include some combination of longitude, latitude and altitude. Longitude and Latitude may be in degrees. Altitude may be in meters above sea level. A listener may listen for location changes. For example, the listener may listen for GPS signals every minute.

Device 12 may include an input/output (I/O) device 15. For instance, the I/O device 15 may be a virtual keyboard, similar to those found on smart phones. Device 12 may include a storage element 20 that is configured to store digital information. The stored digital information stored in the storage element 20 is retrievable via processor 16.

Device 12 includes a display 18 for displaying an alert. The display 18 is capable of displaying information. The display 18 is capable of receiving user touches. A touch sensitive area located adjoining the display, otherwise a touch screen, is capable of receiving touches and relaying that touch based information to the processor 16. That information may be processed by the processor 16 for determining selections or other choices of the user.

Device 12 may be a mobile device, personal computer, laptop computer, tablet computer, PDA, among other types of computing devices.

In an exemplary embodiment, device 12 includes processor 16 that is capable of communicating with storage element 20, the display 18, the receiver 21 and a display 18. Device 14 may also be arranged with a display, receiver or radio member, a display and a storage element. The processor may be of any type of processor suitable for processing data. Storage element 20 may be of any type of storage elements such as disk drives or cloud computing storage and the like.

Receiver 21 is capable of receiving information to provide or otherwise determine location based information by the processor 16. For example, the receiver receives information from a radio satellite. The radio satellite may provide GPS location information or other similar information for determining device 12 location.

Device 12 may be capable of storing in storage element 20 and executing a plurality of applications. In a particular embodiment, the Device 12 includes applications relating to reminder based applications. Alternatively, the applications may be stored remotely, in which case, the applications may be executed either locally on Device 12 or executed remotely on a server or other cloud based service.

At least one application allows a user to set reminders for various reminder based items. For example, reminder based items include, inter alia, calendar events, tasks, memos, emails, voicemails, social media events.

In a particular embodiment, the at least one application allows a user to enter a at least one reminder based on at least one class. The class includes a plurality of members. The members have a number of common attributes.

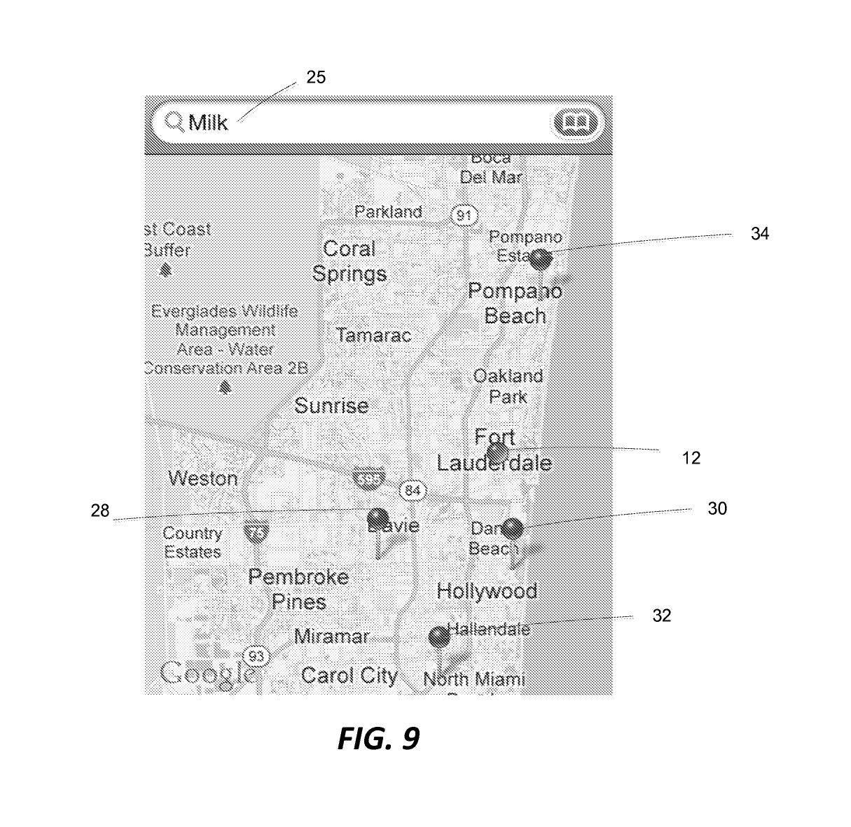

For exemplary purposes, the user may wish to purchase milk as shown in FIG. 9. In order to set the reminder, the user sets the class 25 as “milk.” The application will determine the members 27 of the class. For instance, the application may determine that members 27 of the class include food stores 28, drug stores 30, gas stations 32, farmers market 34 and etc, that carry milk.

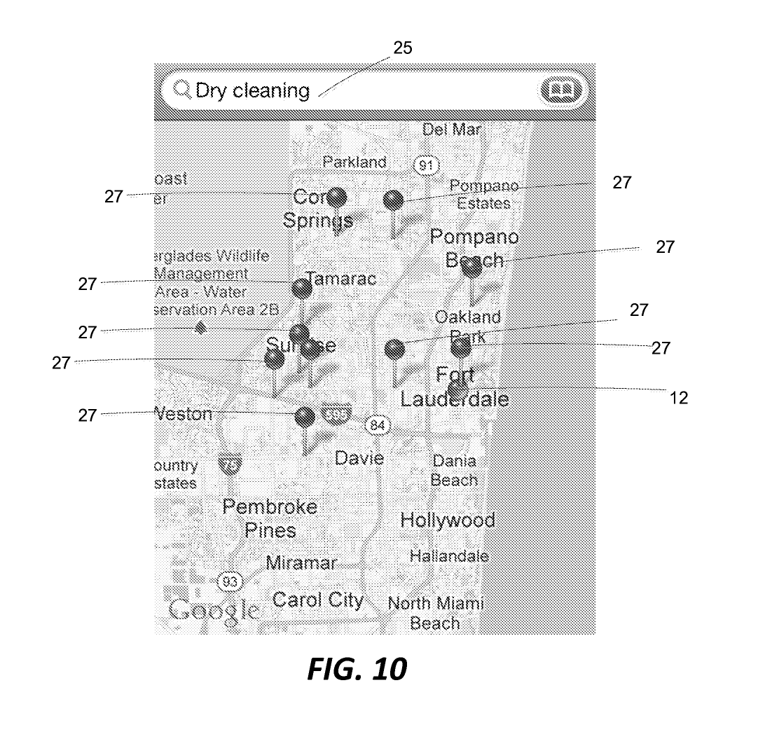

In yet another example, the user may wish to drop off drying cleaning, as exemplified in FIG. 10. In this example, the user does not have a particular dry cleaning location preference. The user could set the reminder as “drying cleaning.” The members 27 of the class 25 would include any dry cleaning establishment/service. Additionally, for example, the user could set the class as “dry cleaning that costs less than $1.25 per shirt.” Thus, the the device 12 could monitor the surrounding location of the device 12 for dry cleaning establishments (members of the class) that cost less than the specified cost per shirt. The class may be as broad or as narrow as the user's creativity. Alternatively, the user may want a reminder to visit a food store, such as Publix.

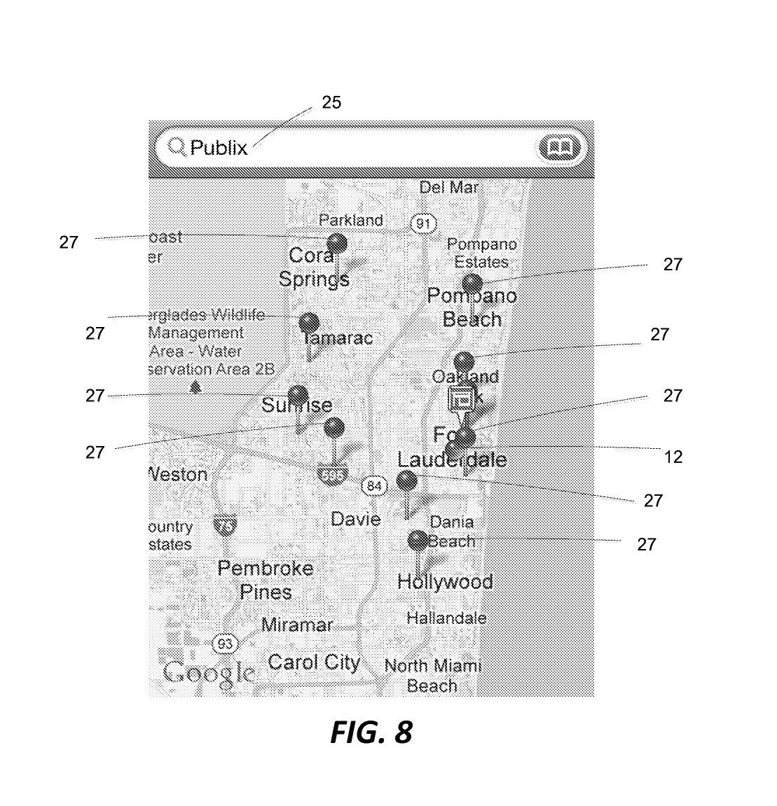

In yet another example, the user could set the class 25 as Publix, as explified in FIG. 8, in which case a plurality of different Publix locations will become members 27 of the class.

It yet another example, the user sets the class 25 to identify members 27, the members based on a plurality of homes, such as a homes for sale or for lease, where home can be a single family home, townhouse, apartment or condo.

The class 25 can be of any type. The class 25 can be a type of person, place, thing or idea, such as a particular chain(s) of restaurant(s). The class can be a good, or service. The members 27 will include a plurality of locations based on the desired class.

In an embodiment, monitoring will commence immediately upon storing the triggering event. Alternatively, monitoring may not commence until a period of time after storing the trigger. If monitoring does not commence immediately, the period of time for commencing may be set by the user or alternatively may be automatically determined.

In a further example, the application allows a user to set the type of good or service that the user wishes to purchase, i.e., the class. The location of device 12 is monitored. If determined that device 12 is within a threshold of at least one member of the class, a reminder can be generated. The reminder can be an email, SMS message, alarm, alert, or other visual or audial alert.

In an embodiment an alert can be generated by moving within a threshold location of a member 27 of a class 25. Thus, if a user wants a reminder to visit any member within the class, an alert is executed/generated upon coming into close proximity to one member of the class. For example, for any of at least one retail store in a chain of stores, the user can set a trigger to alert by coming within a proximity of any of at least one particular store of the retail chain. Additionally, the alert may be specified to only alert if the trigger is triggered, as specified herein, on specific date, time, or such similar event. For example, alerting only: on Mondays; once per month; once per year; within a specific date range.

For yet another example, the user may desire to visit a particular thing. The user sets a trigger that alerts to at least one class, the class having a plurality of members having common characteristic, attribute, quality or property. The class itself is not directed towards any particular location. For example, the user may wish to visit a waterfall, without a particular waterfall in mind. The class could be set as “waterfall” and the members will include a plurality of different waterfalls.

Thus, the reminder will trigger when device 12 comes within a threshold proximity to a common characteristic of the class. The threshold may be a distance, radius, region, driving distance or a driving time. It is contemplated that driving time could be substituted for walking time, flying time, biking time, etc. It is contemplated that driving distance could be substituted for walking distance, flying distance, biking distance, etc.

For yet an additional example, an alert may be generated to alarm the user of the proximity of a location for which is useful to the user. For example, the user previously indicated that the user wishes to buy a pint of milk, in which case passing a gas station that sells a pint of milk will alert the user of the location that has the desired item, event or other reminder. In this case, the class is based upon member locations that sell milk. The members of the class may be of any type of members of the class that relates to the class or otherwise share common characteristics with the class. The user does not set the particular location for which an alert will be generated. Instead, the user chooses and sets the class whereby the locations which will trigger an alert will be determined automatically.

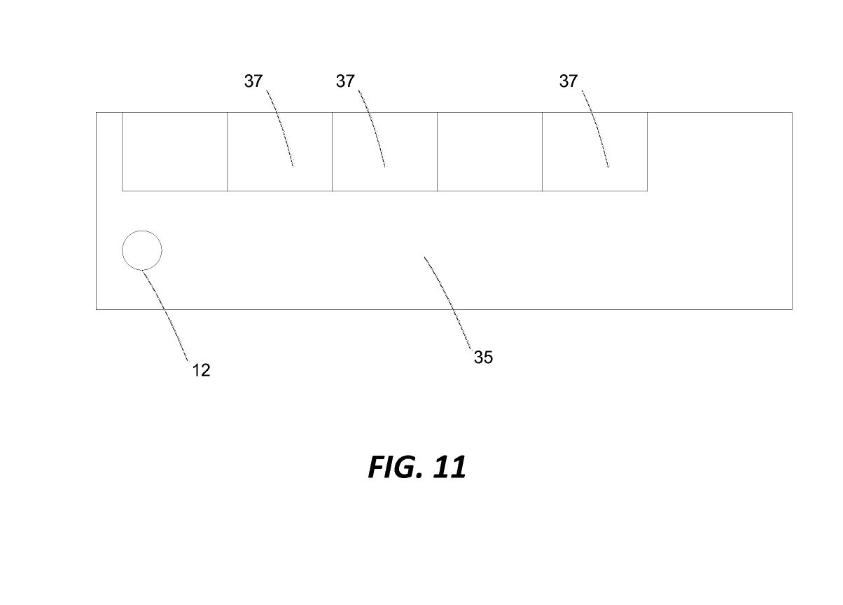

Alternatively, an exemplary embodiment could be useful in a work environment. A hospital employee or other person may set a trigger based reminder that will alert on the hospital floor 35 when device 12 comes within a proximity to a member of the class. For example, the class may be based on any patient who hasn't had their legs elevated within a particular time period, but needs to have their legs elevated in that time period. An alert will be generated on device 12 when that device comes in close proximity to any patient or their room 37 for which a need to elevate the patients legs exists, exemplified in FIG. 11.

As another example, the user may have specified the class as a dry cleaning business. Of note, this example, like all examples found herein, is not limited to specific class members such as dry cleaning businesses. A plurality of independently owned dry cleaning businesses would be members of the class. An alert will be generated determining that the determined location of device 12 is within a threshold of any dry cleaning operation. It is contemplated that the user wishes to drop off laundry at any dry cleaning business, and, it is also contemplated that after dropping off laundry, the user will need to return to that specific member location to pickup dry cleaning thereafter. Therefore, an additional reminder may automatically be set to alert in the future to remind the user to return to that specific location. Alternatively, a request may be generated by device 12 upon alerting of at least one member of a class to determine whether a new reminder based on either that specific location or based on a date, time, etc, should be stored, monitored and alert thereafter.

An alert may be generated based on a stored location for a particular store. An alert may also be generated based upon coming within a proximity of at least one member of at least one class. The class may be of a similar classification, category, species, genre, or attribute.

The alert may additionally include information to inform the user of other locations that have the item for purchase. In particular, the alert may include information to inform the user of discounts for a good or service. When the alert informs the user of other locations that sell the good or service, the alert may list the items in order of price. Alternatively, the goods or services may be listed in order of distance from the device 12, such as the current location of the device. The user may be able to toggle between price and location or a combination thereof.

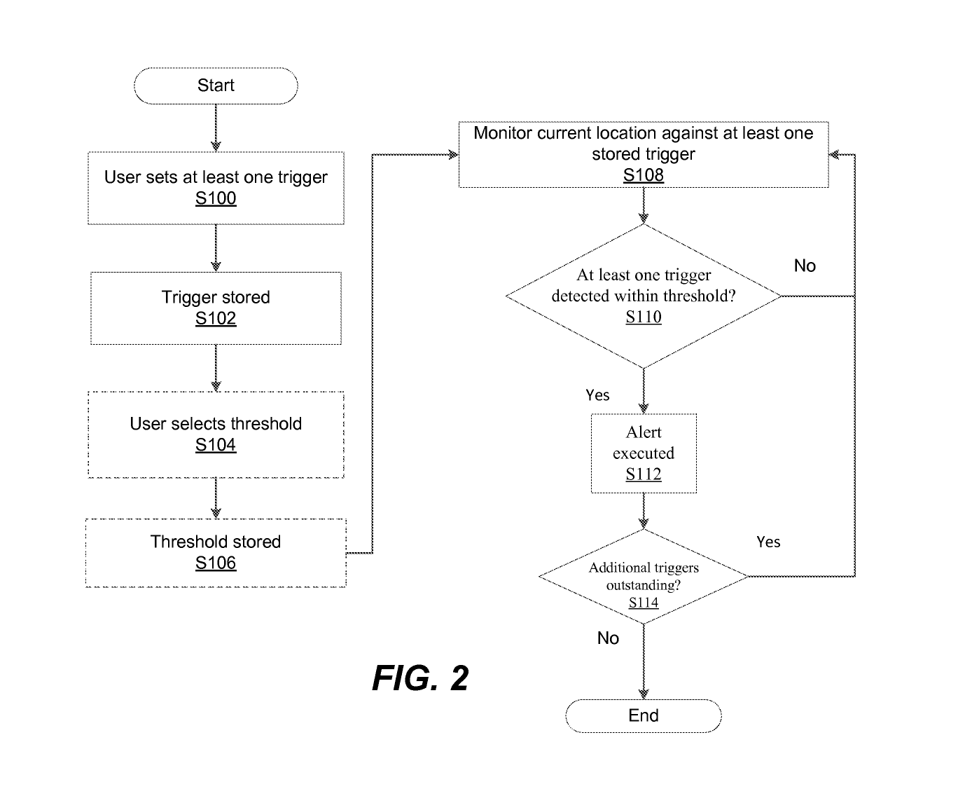

Referring now to FIG. 2, is shown a process of monitoring triggers that alert a user. The user sets at least one trigger (Block S100). The trigger may be a good or service. Alternatively, the trigger may be at least one class or at least one category.

The trigger is stored in storage element 20 (Block S102). The user may select a monitoring threshold (Block S104). The threshold is stored (Block S106). The threshold may be stored into storage element 20. Alternatively, the monitoring threshold may be predetermined. In a particular embodiment, the monitoring threshold may be automatically determined based on the class.

The threshold may be a radius or a distance from device 12. Alternatively, the threshold may be a radius or distance from the trigger.

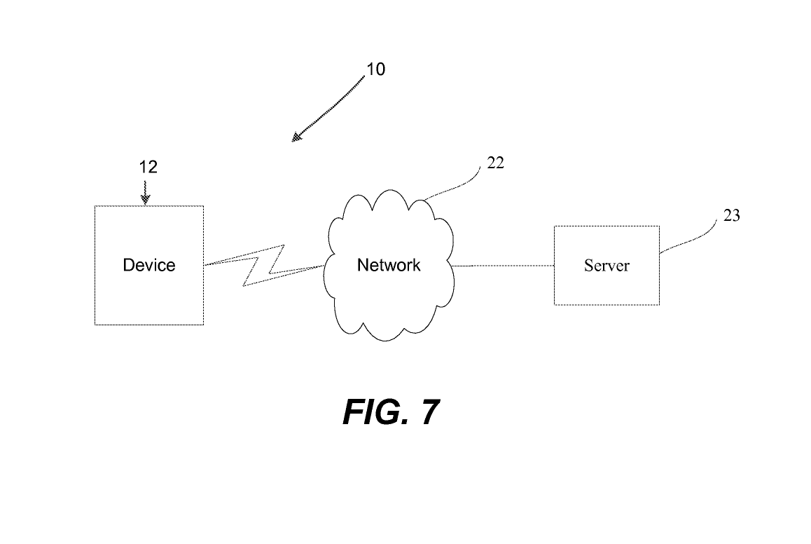

In an embodiment, the location of device 12 may be monitored against at least one stored trigger (Block S108). In an instance, the processor 16 is capable of monitoring the location of device 12 against at least one stored trigger. In another instance, a server 23 connected across the network 22 is capable of monitoring the location of device 12 against at least one stored trigger, as described in FIG. 7. It is contemplated that any monitoring, mathematical operation and/or alerting discussed herein performed by a processor can alternatively be performed by server 23.

A determination is made as to whether at least one trigger is detected within threshold (Block S110). If a trigger is detected within the threshold, an alert is executed (Block S112). A determination is made as to whether additional triggers are outstanding (Block S114). If additional triggers are outstanding, the processor 16 may continue to monitor the current location against at least one stored trigger (Block S108). If there are no triggers outstanding, the processor shall stop monitoring the current location for a trigger.

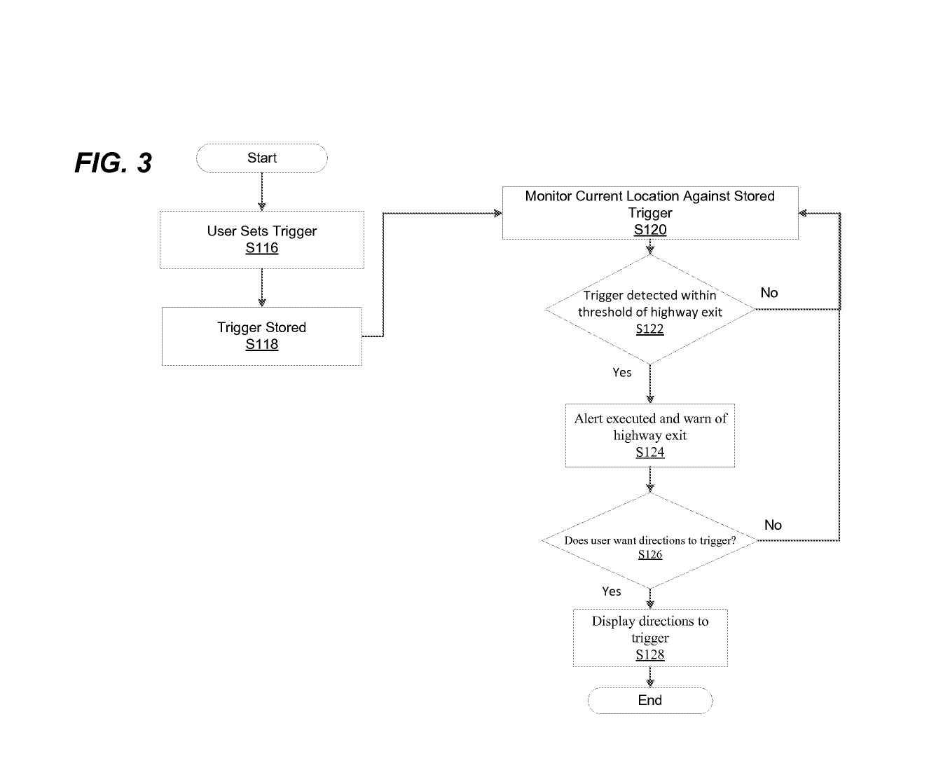

Referring now to FIG. 3, is shown a process of monitoring triggers that alert a user on the highway, the triggers based on at least one class having a plurality of members. The user sets at least one trigger (Block S116). The trigger may be a good or service or based on a class or a category. The trigger is stored in storage element 20 (Block S118). The processor 16 monitors at least one trigger (Block S120). The processor determines the distance between the at least one monitored trigger in relation to device 12. A determination is made whether the trigger is detected within a threshold of a highway exit (Block S122). The highway exit should be in proximate relation to device 12. If a trigger is determined to be within a threshold of a highway exit, the highway exit being in proximate relation to device 12, an alert is executed (Block S124). A determination is made as to whether the user wants directions to the trigger (Block S126). For example, the user may select, physically, verbally or otherwise, to indicate that the user wants the device 12 to display directions to the trigger. If it is determined that the user wants directions to the trigger, the processor 16 shall display on display 18 directions to the trigger (Block S128). Processor 16 may be capable of causing the directions to be displayed on a vehicle's visual display, such as a build in vehicle GPS display (not shown herein). If there are no triggers outstanding, the processor shall stop monitoring the current location for a trigger.

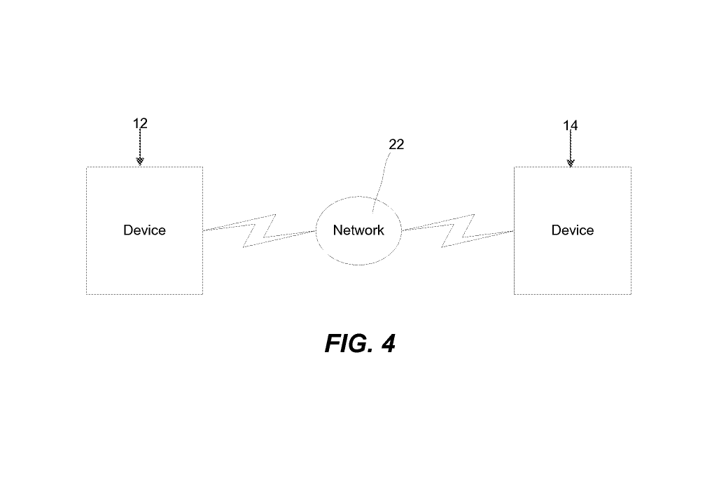

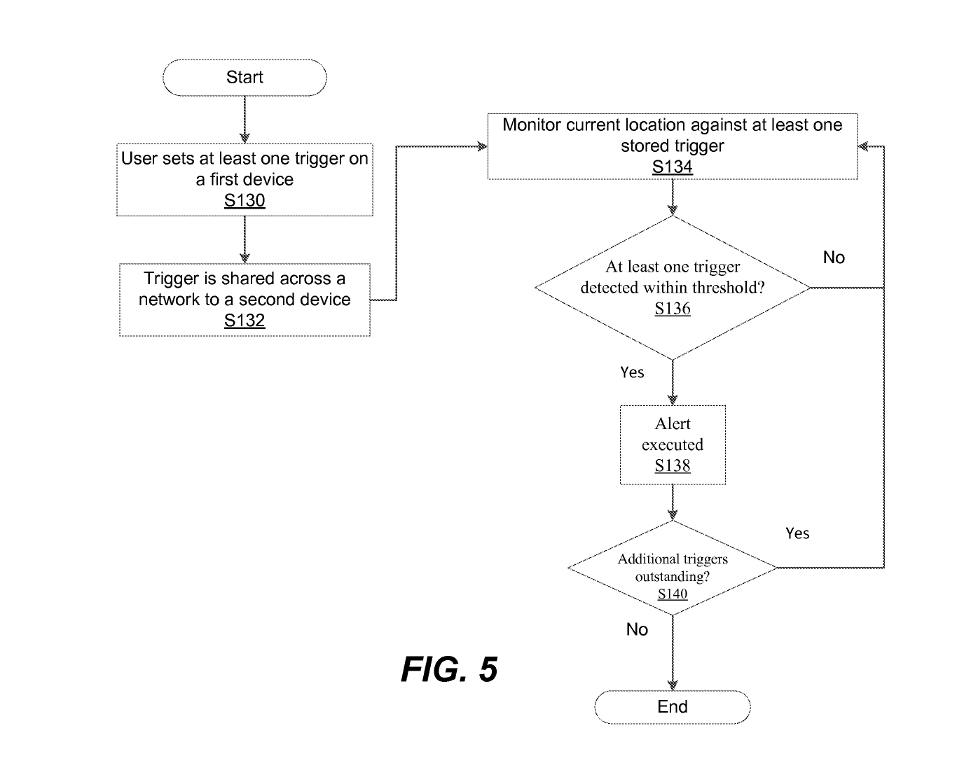

Referring now to FIGS. 4 and 5, is shown an embodiment in which a trigger may be shared between devices. The user sets at least one trigger on Device 12 (Block S130). The trigger may be based on one particular location. Alternatively, the trigger is based on a class. Device 12 is capable of sharing triggers over network 22 with device 14 (Block S132). Alternatively, device 12 stores a trigger over network 22, which may be stored in the cloud and retrievable by Device 14. Device 14 will then monitor at least one trigger (Block S134). A determination is made as to whether a trigger is detected within a threshold (Block 136). If a trigger is detected within a threshold, then an alert is executed on device 14. A display on device 14 may present a visual or audial indication of the trigger existing within a threshold of device 14.

A determination is made as to whether additional triggers are outstanding (Block S140). If there are triggers outstanding, then device 14 may continue to monitor the current location of device 14 against at least one stored trigger.

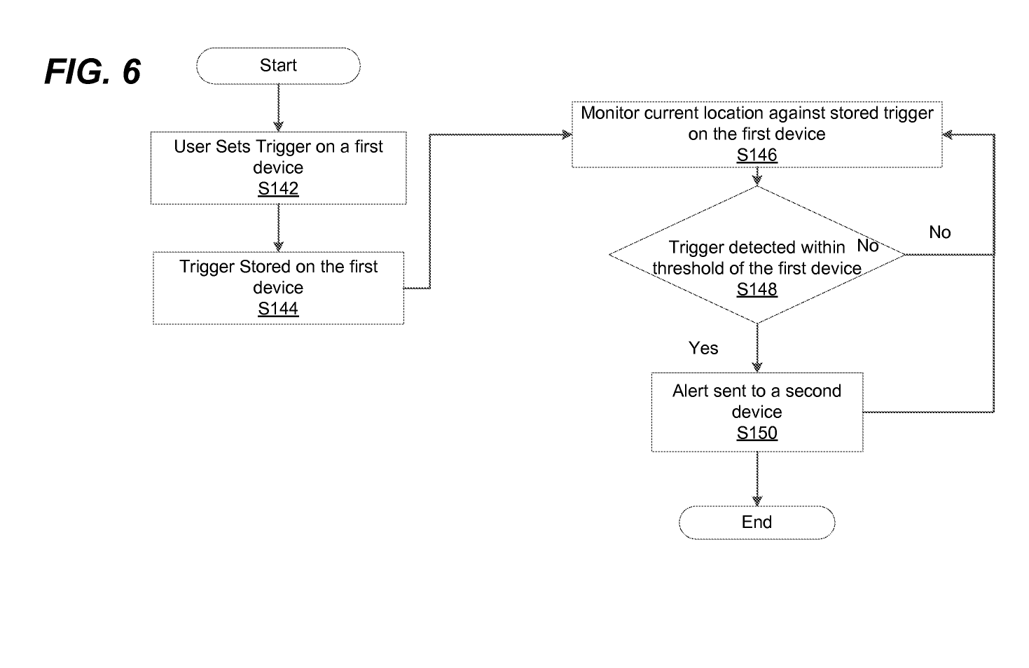

Referring now to FIG. 6, is an exemplary embodiment for which a detected trigger on device 12 shall provide an alert to device 14 over network 22. The alert may be an email, SMS or other visual or audible alert on device 14. The user sets at least one trigger on a first device, e.g., device 12 (Block S142). The trigger is stored on the first device (Block S144). The first device shall monitor the current location against the stored trigger on the first device (Block S146). A determination is made as to whether the trigger is detected within a threshold of the first device based on received location information (Block S148). If a trigger is detected within a threshold of the first device based on received location information, an alert is sent to a second device, e.g., device 14 (Block S150). An alert may also be executed on the first device. The trigger may be based on a one specific location. Alternatively, the trigger is based on a class. The trigger may be based on a combination of one more specific locations and one or more triggers based on a class.

What is claimed is:

1. A mobile computing device for location based reminders, the mobile computing device comprising:
a location based reminder application comprising a location for the mobile computing device, said reminder application to monitor at least one class, said class comprising a plurality of members; and
said application provides a reminder when said location is near at least one member of said class.

2. The mobile computing device of claim 1, wherein said plurality of members are automatically generated based on said at least one class.

3. The mobile computing device of claim 1, wherein near is defined as being within a proximity to said at least one member of said class.

4. The mobile computing device of claim 1, wherein said class is populated based on at least one of a similar classification, category, species, genre and attribute.

5. The mobile computing device of claim 1, wherein said application provides a second reminder when said location matches the member that caused the first reminder.

6. A method for location based reminders, the method comprising:
determining, via a computing processor, members of at least one class, at least one class formed of a plurality of members; and
executing an alert when a device is within a threshold range of at least one determined member of said class.

7. A method for location based reminders, the method comprising:
monitoring, via a computing processor, for a trigger, said trigger based on a plurality of class members; and
alerting that a device is within a threshold range of at least one determined member of said class.

8. The method of claim 7 further comprising causing monitoring for a second trigger, said second trigger based on said at least one determined member.

9. The method of claim 7 further comprising monitoring for at least one additional trigger.

10. The method of claim 7 further comprising monitoring said trigger in relation to at least one highway exit.

11. The method of claim 7 further comprising causing display of at least one price of a commodity.

12. The method of claim 7 further comprising causing display of at least one location having a commodity.

13. The method of claim 7 further comprising causing display of directions to at least one location.

14. The method of claim 7 wherein alerting on a second device.

15. The method of claim 7 wherein alerting is defined as at least one of email, SMS message, alarm, visual alert and audial alert.

16. The method of claim 7 wherein said threshold range is defined as at least one of a radius, a region, a distance, and a time.

17. The method of claim 7 wherein said threshold range is further defined as at least one of a driving distance, a walking distance, a flying distance and a biking distance.

18. The method of claim 7 wherein said threshold range is further defined as at least one of a driving time, a walking time, a flying time and a biking time.
